(19) United States
(12) Patent Application Publication
(10) Pub. No.: US 2023/0134663 A1
(43) Pub. Date: May 4, 2023

(54) Transforming Surveillance Sensor Data into Event Metadata, Bounding Boxes, Recognized Object Classes, Learning Density Patterns, Variation Trends, Normality, Projections, Topology; Determining Variances Out of Normal Range and Security Events; and Initiating Remediation and Actuating Physical Access Control Facilitation

(71) Applicant: STEVEN ROSKOWSKI, AUSTIN, TX (US)

(72) Inventor: STEVEN ROSKOWSKI, AUSTIN, TX (US)

(21) Appl. No.: 17/861,202

(22) Filed: Jul. 9, 2022

Related U.S. Application Data
(60) Provisional application No. 63/274,927, filed on Nov. 2, 2021.

(51) Int. Cl. H04N 7/18; G06V 20/40; G06V 20/52

(52) U.S. Cl. CPC H04N 7/181; H04N 7/188; G06V 20/47; G06V 20/52; H04W 84/12

(57) ABSTRACT

A system transforms video frames into event metadata reports on object recognition and occupancy patterns and trends. Each camera distinguishes foreground content and uploads meta data and changes. Occupancy within bounding boxes, and object pre-cognition are transformed to non-image event data sets. Objects and persons of interest are tagged for optical tracking and correlation. Cloud analytics estimate probabilities of occupancy and change. Periodic capture is augmented by expectation of peaks and valleys. Imagery and event meta data across multiple cameras are combined for object recognition. The cloud reports and predicts regions of interest due metrics of occupancy. Each edge device is trained on the local topology of other devices and actuators through which objects may pass before and after entering its region of interest. Edge devices collectively initiate physical access actuator controls, predict events for other edge devices, and transmit alerts when low probability events occur.

### CROSS-REFERENCE TO RELATED APPLICATIONS

This application is a non-provisional application of pending provisional application No. 63/274,927 cfn 1501 filed Nov. 2, 2021 which is incorporated by reference including its figures and benefits from its priority date.

### BACKGROUND

The field of the invention is security surveillance systems using video capture devices. What is needed is a way to digest vast volumes of video streams into information that concerns security and drive video display and analysis based on content and significance.

### SUMMARY

A system transforms a sequence of video frames captured by a security surveillance edge device into event metadata reports on object recognition and occupancy patterns and trends. Each camera is trained to distinguish background from foreground content and to upload meta data and imagery which denotes changes in its viewport. Further training enables sensitivity to regions of high and low probability of occupancy, determination of bounding boxes, and classes of object pre-cognition which are transformed to non-image event data sets.

Specific objects and persons of interest are tagged for optical tracking and correlation within and across viewports and surveillance devices. Based on training from the cloud, edge devices may collectively initiate physical access actuator controls, predict events for other edge devices, and transmit alerts when low probability events are recognized.

A surveillance sensor network trains a variance determination artificial intelligence machine to determine a security event and to actuate physical access denial/optimization facilitators including, display, impedimenta, audio, and illumination controls.

An untrained edge device initially captures video frames on motion and periodic timers. Local analysis uploads low or higher quality images to cloud based on heuristics.

A cloud processor analyzes content and provide regions of interest to train each edge device. Cloud processor analyzes history of images and provide reports on times and locations of high probability of interest. Object recognition of vehicles and persons define boundary boxes.

Aggregation of reports provide peaks and valleys of object occupation independent of motion. Henceforth, the trained edge device is optimized to avoid transmitting low content images and data.

Having a continuously updated range of “normal” object characteristics, when the invention detects People or vehicles traversing a Region of Interest in a non-normal direction or non-normal speed it triggers a display to present an alert, a label, trigger an actuator, or a tracking/tracing search of past and immediate next predicted camera scheduling. A security event is determined when a person abandons a vehicle or package and causes tracking of the person in adjacent camera views. A security event is determined when multiple people exit a vehicle in non-normal stopping location triggers illumination, and near by door actuators. A security event is determined when a vehicle reverses toward a door which triggers actuation of impedimenta and strobes.

### BRIEF DESCRIPTION OF THE DRAWINGS

To further clarify the above and other advantages and features of the present invention, a more particular description of the invention will be rendered by reference to specific embodiments thereof that are illustrated in the appended drawings. Like reference numbers and designations in the various drawings indicate like elements. For purposes of clarity, not every component may be labeled in every drawing. It is appreciated that these drawings depict only typical embodiments of the invention and are therefore not to be considered limiting of its scope. The invention will be described and explained with additional specificity and detail through the use of the accompanying drawings in which:

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating a cloud computing environment in which illustrative embodiments may be implemented;

FIG. 4 is a diagram illustrating an example of abstraction layers of a cloud computing environment in accordance with an illustrative embodiment;

FIG. 5 is a block diagram of a system for acquiring and transforming video frames into security meta data.

FIG. 6 is a flow chart illustrating an exemplary methodology to accommodate peaks and valleys in ranges of metadata.

FIG. 7 is a block diagram illustration of a sensor system coupled to machine learning analysis and training server, coupled to a security event determination device, coupled to at least one physical access control facilitation actuator.

FIGURE REFERENCES

| Name | Reference # | FIG. | Claim |
|---|---|---|---|
| Computing system | | 1-4 | |
| spare | | | |
| Scene Summary System | 500 | 5 | |
| Smartened security surveillance edge | 511, 515 | 5 | 1 |
| devices | | | |
| Video Frame Foreground Content Event | 520 | 5 | 1 |
| MetaData Set | | | |
| Cloud Analytics Processing Unit | 530 | | 1 |
| Bounding Box Coordinates | 540 | | 1 |
| Object Signature Vectors | 550 | | 2 |
| Regional Probability of Interest | 560 | | 2 |
| Edge Device Directed Topology | 570 | | 3 |
| Abnormal Events Rules | 580 | | 3 |
| Self-Actualized Security Surveillance | 592, 594 | | 4 |
| Edge Devices | | | |
| Physical Access Actuators, Alarms | 596, 598 | | 4 |

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

### Embodiments of the Invention

### Acquisition and Transformation

A system transforms a sequence of video frames captured by a security surveillance edge device into event metadata reports on object recognition and occupancy patterns and trends.

Each camera is trained to distinguish background from foreground content and to upload meta data and imagery which denotes changes in its viewport.

Further training enables sensitivity to regions of high and low probability of occupancy, determination of bounding boxes, and classes of object pre-cognition which are transformed to non-image event data sets.

Specific objects and persons of interest are tagged for optical tracking and correlation within and across viewports and surveillance devices. E.g. public safety officers and their weapons should not be separated by some quantity of pixel blocks.

### Integration and Recognition

A cloud integrator of video frame analytics trains edge devices on high and low probability of occupancy and expected rates of change.

Periodic capture and upload of imagery is augmented by expectation of peaks and valleys derived from recent trends and patterns.

Imagery and event meta data from a plurality of edge devices is combined for object recognition or classification which correlate across frames from multiple cameras.

Based on object classification and recognition, the cloud reports historical and predicts likely regions of interest due to density or scarcity of occupancy within timeframes.

### Education and Actuation

Each edge device is trained on the local topology with respect to other security surveillance edge devices and actuators through which objects may pass before and after entering its region of interest.

Each may trigger or be triggered to live stream video images by or from another near its scope.

Evacuate, lockdown, or trace action requests are peer to peer messages an edge may issue or implement based on training on objects in and transit through regions of high and low probability. Based on training from the cloud, edge devices may collectively initiate physical access actuator controls, predict events for other edge devices, and transmit alerts when low probability events are recognized.

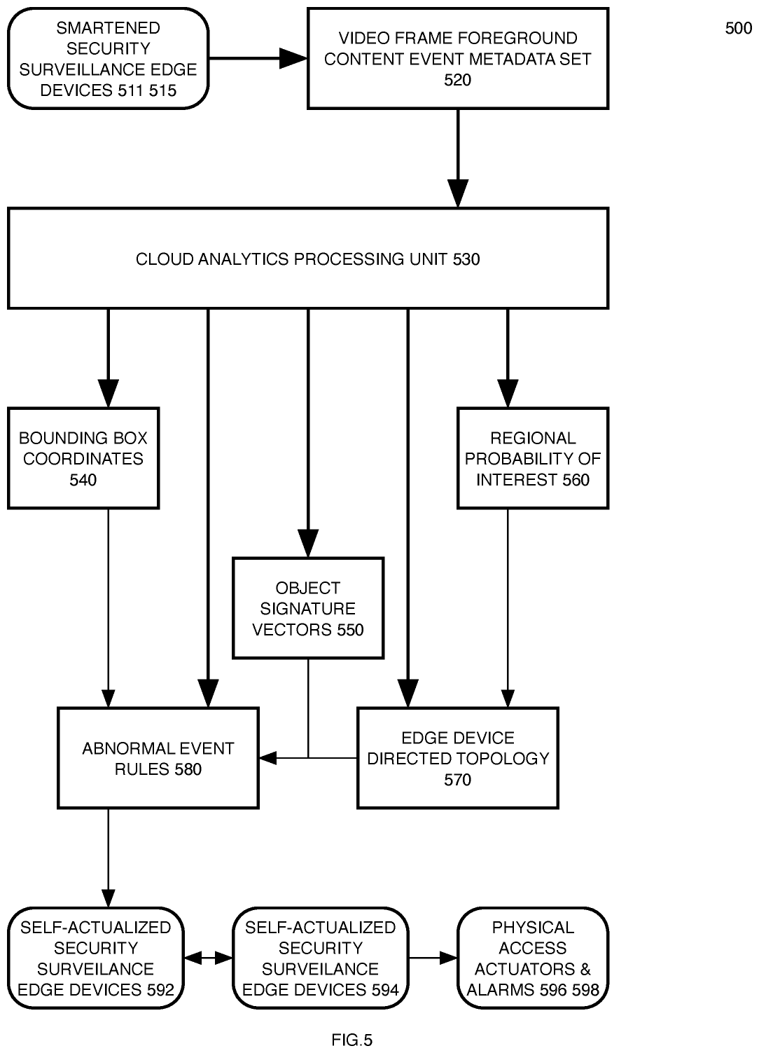

Referring now to FIG. 5, a scene summary system 500 includes:

a plurality of Smartened Security Surveillance Edge devices 511 515; configured to determine and transmit Video Frame Foreground Content Event Metadata 520; to

a Cloud Analytics Processing Unit 530; whereby, prerecognition of events is captured by distinguishing a foreground content change from background content in each video frame and whereby communication performance is improved by only transmitting meta data on foreground content.

An Object Signature Vectors store 550; and

A Regional Probability of Interest store 560, are both communicatively coupled to the Cloud Analytics Processing Unit 530, whereby object recognition indicia are stored and the most and least likely positions of objects in the video frames are stored when determined by the Cloud Analytics Processing Unit based on bounding box coordinates 540 and foreground content event meta data.

An Edge Device Directed Topology store 570; and

An Abnormal Events Rules store 580, are both communicatively coupled to the Cloud Analytics Processing Unit 530, whereby each edge device is connected to its adjacent edge devices by directional indicia for an object normally arriving and by directional indicia for an object normally departing; and whereby said Abnormal Events Rules include trigger conditions which when true, cause action requests to be recorded and transmitted through the communication channels.

A plurality of self-actualized security surveillance edge devices (S-AED) 592, 594 are communicatively coupled to the Abnormal Events Rules store 580 and to each other S-AED; and further coupled to at least one Physical Access Actuator 596 and at least one Physical Access Alarm 598; where by upon determining a trigger condition as an Abnormal Event is TRUE, a first S-AED 592 transmits an action request to at least one of a second S-AED 594, a physical access actuator 596, and a physical access alarm 598.

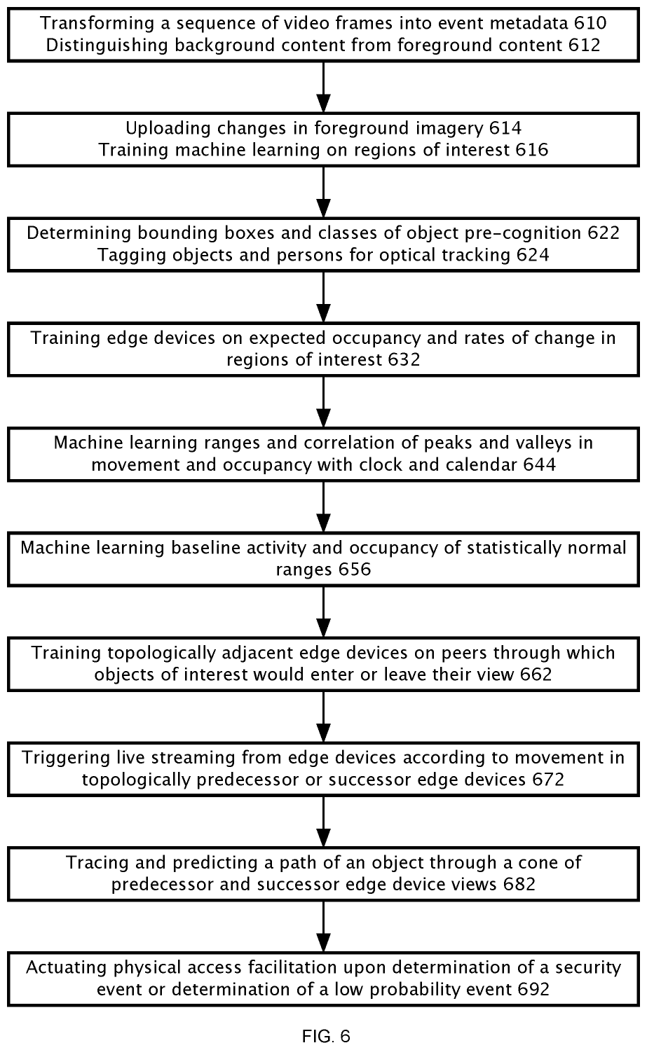

Referring to the Figures, FIG. 6 is a flowchart of methods comprising:

Transforming a sequence of video frames into event metadata 610;

Distinguishing background content from foreground content 612;

Uploading changes in foreground imagery 614;

Training machine learning on regions of interest (high or low probability of occupancy) 616;

Determining bounding boxes and classes of object pre-cognition 622;

Tagging objects and persons for optical tracking 624;

Training edge devices on expected occupancy and rates of change in regions of interest 632;

Machine learning ranges and correlation of peaks and valleys in movement and occupancy with clock and calendar 644;

Machine learning baseline activity and occupancy of statistically normal ranges 656;

Training topologically adjacent edge devices on peers through which objects of interest would enter or leave their view 662;

Triggering live streaming from edge devices according to movement in topologically predecessor or successor edge devices 672;

Tracing and predicting a path of an object through a cone of predecessor and successor edge device views 682;

Actuating physical access facilitation upon determination of a security event or determination of a low probability event 692.

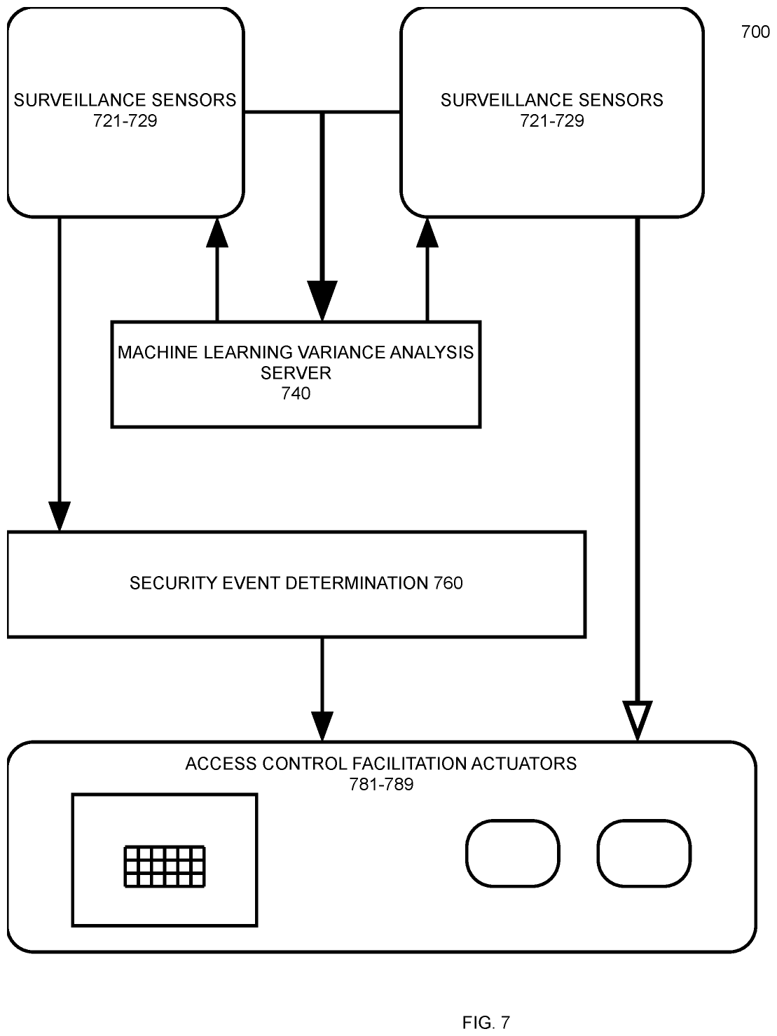

Referring now to another embodiment of the invention, FIG. 7 illustrates a security surveillance system 700 which includes a plurality of content triggered mesh network of surveillance sensors 721-729, said sensors comprising video cameras which transmit metadata concerning foreground objects within a region of interest; coupled to a machine learning variance analysis server 740, said server comprising means for determination of a normal range of content from historical aggregation of meta data and means for training said sensor on a region of interest; coupled to

a security event determination rule filter device 760, said filter triggering on intrusion of an object type into an incompatible region of interest; coupled to

a physical access control facilitation actuator 781-789, said actuator enabling portal operation between a first responder and location of incident or object interception.

In an embodiment, a content-triggered mesh network of surveillance sensor further includes at least one of:

an optical sensor; a chemical sensor; a vibration sensor; a combustion sensor; an audio sensor; an acceleration sensor; an infrared sensor; a temperature sensor; a three dimensional image sensor; an electro-magnetic sensor; a microphone and speaker; a pressure sensor; and a radar transceiver.

In an embodiment, a machine learning variance analysis server further includes at least one of:
means for training a sensor on regions of interest;
means for training a sensor to distinguish between objects in foreground and objects in background;
means for aggregating metadata by location, by hour of day, by day of week, by calendar;
means for learning a normal range of metadata by location, by hour of day, by day of week, by calendar;
means for determining adjacency of cameras capturing the same objects within a period of time;
means for determining a range of metadata for rate of change and direction of travel across a plurality of physically adjacent cameras;
means for determining linger times, waiting time, length of queues; and
means for training sensors on upload criteria based on content and change of content.

In an embodiment, a security event determination rule filter further comprises:
a circuit which triggers on a current metadata which is outside a machine learned range of normal historical value by a standard deviation;
a circuit which triggers when an object exiting a region of interest is unequal to the object entering said region of interest;
a circuit which triggers when occupants exit a vehicle stopped in a region of interest;
a circuit which triggers when a package is discarded in a region of interest;
a circuit which triggers when a type of object intrudes on a region of interest which is inappropriate for the type of object; and
a circuit which triggers on an amplitude of metadata which exceeds a threshold.

In an embodiment, a physical access control facilitation actuator further includes at least one of:
a mobile security sensor elevator;
an airborne security sensor launcher;
a portal actuator;
a barrier actuator;
a display of a map guiding a first responder to most direct and quickest arrival to an incident or intercept location;
a display of a map and location of a security event;
a display of a map and video stream of most likely paths available to an object subsequent to a security event;
a display of a map and video streams of path taken by an object preceding a security event; and,
alarm, announcements, illumination, or environmental adjustments.

Applicant discloses that means include electronic circuits, programmable logic devices, and processors configured by instructions encoded in non-transitory media. Manual coding and machine learning to determine averages, medians, means, and normal statistics of aggregated metadata are well known to those skilled in the art without limit to current implementations.

An untrained edge device initially captures video frames on motion and periodic timers. Local analysis uploads low or higher quality images to cloud based on heuristics.

A cloud processor analyzes content and provide regions of interest to train each edge device. Cloud processor analyzes history of images and provide reports on times and locations of high probability of interest. Object recognition of vehicles and persons define boundary boxes. Aggregation of reports provide peaks and valleys of object occupation independent of motion. Henceforth, the trained edge device is optimized to avoid transmitting low content images and data.

In an embodiment, the cloud processor trains edge device with calendar and schedules of times to increase samples of capture and upload of static images of interest. In an embodiment, the cloud processor downloads boundary boxes to Edge to trigger sampling and meta data collection. Cloud processor can trace likely contiguous/overlapping views among edge device to discover a topography of the camera system as objects move through the aggregate viewspace. Additionally, cloud analysis adds labelling for contents of bounding boxes, numbers, and qualities/quantities.

Cloud analysis dynamically sets standard deviation thresholds on highly likely and highly unlikely occupancy of regions. E.g. queues, parking, roadways, hangouts, predicts trending.

In an embodiment, edge devices exchange and relay alerts to “nearby” peers to live stream or to nearby actuators to control portals, alarms, and illumination when activity or occupancy within their bounding boxes is statistically deviant. E.g. rate of travel in vehicles, stopping in travel paths, rapid disgorgement of occupants, mobbing entrances or exits in narrow timespans. Cloud processor sets triggers for volume, density, traffic flow, occupancy of bounding boxes. In an embodiment, edge devices anticipate which other device should anticipate an object moving between views.

A cloud processor receives an alert when traffic across viewports occurs in the wrong direction or above or below a normal range of velocity. (frog's eye only alerts the frog's brain for incoming or stationary targets). Cloud processor trains edge devices to work together on tracing objects when volume or velocity exceeds a standard deviation.

Another aspect of the invention is a surveillance sensor network which trains a variance determination artificial intelligence machine to determine a security event and to actuate physical access denial/optimization facilitators.

In an embodiment, a surveillance sensor network trains a variance determination artificial intelligence machine to determine a security event and to actuate physical access denial/optimization facilitators including, display, impedimenta, audio, and illumination controls.

A plurality of Surveillance Sensor Devices in a Mesh Network includes:
sensors for heat/vibration/chemicals/pressure;
Video capture devices configured for:
Content driven triggered transmission;
Object indicia capture;
Object recognition;
Movement, direction, density, scarcity sensors;
Deblurring image transformation;
Regions of interest/disinterest in bitmaps;
Topology/neighborhood awareness.

A Variance Determination Machine Learning Apparatus includes
Machine learning of normal ranges of action/inaction, occupancy, speed, direction, density, scarcity, repetition,
Adjustment of norms by clock, day of week, holidays,
Sampling of history to establish divergence from normal range,
Sensor is below threshold of expected transmission rate,
Summarizing scenes by numbers, density, linger time, wait time, queue length, disorder, rates of change.

Event Determination includes suddenly departing a vehicle;
discarding a package;
people exiting not equal to entering;
When vehicle intrudes on pedestrian space;
Conflict, amplitude, optical, chemical impulse, sounds, posture.

Actuating access control facilitators includes
guiding a first responder to the incident or intercept location;
a map and location of a security event;
with likely path of an intruder post event and pre-event;
displays of a cone of potential paths of an intruder pre-event and post-event;
Actuating a sensor launcher.

In an embodiment, the surveillance sensor network trains a variance determination artificial intelligence machine to determine a security event and to actuate physical access denial/optimization facilitators including, display, impedimenta, audio, and illumination controls.

A plurality of Surveillance Sensor Devices in a Mesh Network includes:
Non-video sensors for heat/vibration/chemicals/pressure;
Video capture devices;
Content driven triggered transmission;
Object indicia capture;
Object recognition;
Movement, direction, density, scarcity sensors;
Deblurring image transformation;
Regions of interest/disinterest in bitmaps;
Topology/neighborhood awareness.

A Variance Determination Machine Learning Apparatus includes
Machine learning of normal ranges of action/inaction, occupancy, speed, direction, density, scarcity, repetition,
Adjustment of norms by clock, day of week, holidays,
Sampling of history to establish divergence from normal range,
Sensor is below threshold of expected transmission rate,
Summarizing scenes by numbers, density, linger time, wait time, queue length, disorder, rates of change,

A Security Event Determination Apparatus includes
When N-occupants suddenly depart a vehicle;
When bearer discards a package;
When objects exiting not equal to objects entering;
When vehicle intrudes on pedestrian space and vice versa;
Conflict, amplitude, optical, chemical impulse, sounds, posture

Actuating access control facilitators includes
A display guiding a first responder to a most direct and quickest arrival to the incident or intercept location;
A display illustrating a map and location of a security event;
A display illustrating a map and likely path of an intruder post event;
A display illustrating a map and likely path of an intruder pre-event;
A plurality of video displays of a cone of potential paths of an intruder pre-event;
A plurality of video displays of a cone of potential paths of an intruder post-event;
Actuating a security sensor launcher.

Advantageously, the base system is expandable to provide distinguishing capabilities by applying machine learning to the metadata resulting from transforming the video streams in storage or dynamically at the edge.

A machine learning method dynamically determines Regions of Interest by accumulating over time where cars or people normally queue and where they are generally absent or unusual.

Having a continuously updated range of “normal” object characteristics, when the invention detects People or vehicles traversing a Region of Interest in a non-normal direction or non-normal speed it triggers a display to present an alert, a label, trigger an actuator, or a tracking/tracing search of past and immediate next predicted camera scheduling.
A person abandoning a vehicle or package causes an alert and tracking of the person in adjacent camera views.
Multiple people exiting a vehicle in non-normal stopping location triggers illumination, and near by door actuators.
Vehicle reversing toward a door causes impedimenta and strobes.
Aggregating meta data over time enables determination of
By comparisons of snapshot N and N−1: rate of change
Locations where people and vehicles gather/linger common waiting areas
Quantification of queue dynamics, average/long/short distributions
Alert when packages/luggage is unattended
Alert when cars abandoned/stopped inappropriately
Determine exact drop and pickup of packages
Which snapshot did object first appear backward search in time.

By products of such an advanced surveillance system include reports of:
Comparison of accumulated metadata Sets
   Determination of “Normal scenes” mostly/largely invariant over multiple Sets
   For each set, which things diverge from historically “Normal Scenes”
Alert when density of people exceeds standard deviate %
Alert when car is exceeding immobile in a position of scene
Auto generate regions of interest for scoping/alerting
Auto generate labels and comments
Auto generate “normal” parking spots from higher occupancy over many Sets.

### CONCLUSION

The claimed invention may be easily distinguished from conventional surveillance systems by being content driven rather than motion driven or periodically uploaded. The invention is distinguished not only by determining security events that are at variance from learned normal ranges but displaying why they are out of the normal range. The invention is distinguished by transformation of a sequence of video frames into event metadata about objects, occupancy, direction, speed, and trends.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

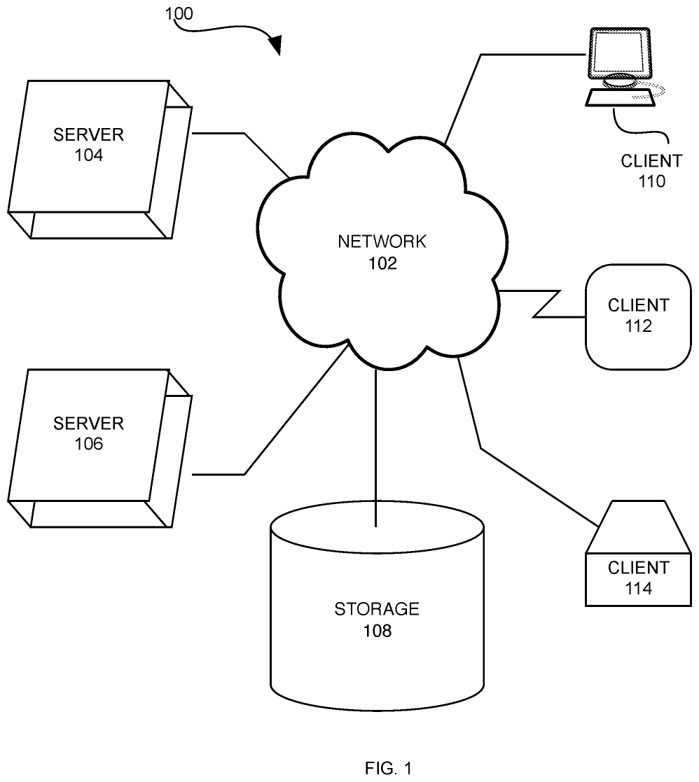

With reference now to the figures, and in particular, with reference to FIGS. 1-4, diagrams of data processing environments are provided in which illustrative embodiments may be implemented. It should be appreciated that FIGS. 1-4 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables. Also, network 102 may be, for example, a private network, a public network, a hybrid network, a corporate network, or the like.

In the depicted example, server 104 and server 106 connect to network 102, along with storage 108. Server 104 and server 106 may be, for example, server computers with high-speed connections to network 102. Also, it should be noted that server 104 and server 106 may represent computing nodes in a cloud environment that manages analysis services for one or more networks and their respective resources. Alternatively, server 104 and server 106 may represent clusters of servers in a data center. Further, server 104 and server 106 may provide information, such as, for example, programs, application, updates, patches, and the like, to the registered client data processing systems.

Client 110, client 112, and client 114 also connect to network 102. In this example, client 110 is shown as desktop or personal computer with wire communication links to network 102. However, it should be noted that client 110 is an example only and may represent other types of data processing systems, such as, for example, a video stream capture, a hub, a credential scanner, an optical scanner, a radio transceiver, a bridge, a laptop computer, handheld computer, smart phone, smart watch, smart television, or the like, with wire or wireless communication links to network 102. A user of client 110 may utilize client 110 to access and utilize the resources and/or services provided by client 112 and client 114. Resources may include, for example, data, documents, software such applications and programs, hardware such as processors, memory, and storage, and the like. Services may include any type of online service, such as, for example, identity services, physical access control services, motor control, storage management, network optimization, version control, network latency reduction, banking services, financial services, governmental services, insurance services, entertainment services, search services, reservation services, and the like. In addition, it should be noted that client 110 may represent a plurality of different client devices corresponding to a plurality of different users.

Clients 112 and 114 are registered clients of server 104 and server 106. In this example, client 112 and client 114 each represents a data processing system, such as a sever computer, that provides the resources and services of network 102. Further, it should be noted that client 112 and client 114 may each represent a plurality of data processing systems corresponding to one or more organizations, enterprises, institutions, agencies, and the like.

Storage 108 is a network storage device capable of storing any type of data in a structured format or an unstructured format. In addition, storage 108 may represent a plurality of network storage devices. Further, storage 108 may store identifiers and network addresses for a plurality of different network security servers, identifiers and network addresses for a plurality of different registered client devices, identifiers for a plurality of different users, and the like. Furthermore, storage unit 108 may store identities, IP and URL addresses, policies, and the like. Moreover, storage unit 108 may store other types of data, such as authentication or credential data that may include user names, passwords, images, and biometric data associated with network users, system administrators, and security analysts, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on network security server 104 and downloaded to client 112 over network 102 for use on client 112.

In the depicted example, network data processing system 100 may be implemented as a number of different types of communication networks, such as, for example, the Internet, an intranet, a local area network, a wide area network, a telecommunications network, or any combination thereof. FIG. 1 is intended as an example only, and not as an architectural limitation for the different illustrative embodiments.

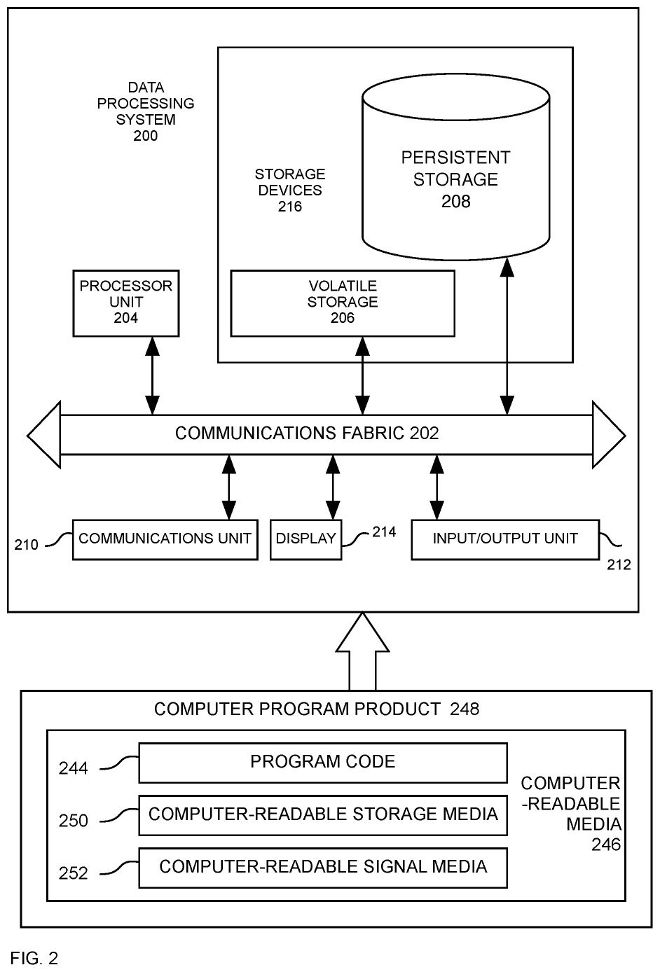

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this illustrative example, data processing system 200 includes communications fabric 202, which provides communications between processor unit 204, volatile storage 206, persistent storage 208, communications unit 210, input/output unit 212, and display 214.

Processor unit 204 serves to execute instructions for software applications and programs that may be loaded into volatile storage 206. Processor unit 204 may be a set of one or more hardware processor devices or may be a multi-core processor, depending on the particular implementation.

Volatile storage 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Volatile storage 206, in these examples, may be, for example, a random-access memory, or any other suitable non-transitory storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into volatile storage 206 for running by processor unit 204. The processes of the different embodiments may be performed by processor unit 204 using computer-implemented instructions, which may be located in a memory apparatus, such as volatile storage 206. These program instructions are referred to as program code, computer usable program code, or computer readable program code that may be read and run by a processor in processor unit 204. The program instructions, in the different embodiments, may be embodied on different physical computer readable storage devices, such as volatile storage 206 or persistent storage 208.

Program code 244 is located in a functional form on computer readable media 246 that is selectively removable and may be loaded onto or transferred to data processing system 200 for running by processor unit 204. Program code 244 and computer readable media 246 form computer program product 248. In one example, computer readable media 246 may be computer readable storage media 250 or computer readable signal media 252. Computer readable storage media 250 may include, for example, an optical or magnetic disc that is inserted or placed into a drive or other device that is part of persistent storage 208 for transfer onto a storage device, such as a hard drive, that is part of persistent storage 208. Computer readable storage media 250 also may take the form of a persistent storage, such as a hard drive, a thumb drive, or a flash memory that is connected to data processing system 200. In some instances, computer readable storage media 250 may not be removable from data processing system 200.

Alternatively, program code 244 may be transferred to data processing system 200 using computer readable signal media 252. Computer readable signal media 252 may be, for example, a propagated data signal containing program code 244. For example, computer readable signal media 252 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 244 may be downloaded over a network to persistent storage 208 from another device or data processing system through computer readable signal media 252 for use within data processing system 200. For instance, program code stored in a computer readable storage media in a data processing system may be downloaded over a network from the data processing system to data processing system 200. The data processing system providing program code 244 may be a server computer, a client computer, or some other device capable of storing and transmitting program code 244.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor or a molecular structure.

As another example, a computer readable storage device in data processing system 200 is any hardware apparatus that may store data. Volatile storage 206, persistent storage 208, and computer readable storage media 250 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, volatile storage 206 or a cache such as found in an interface and memory controller hub that may be present in communications fabric 202.

It is understood that although this disclosure includes a detailed description on cloud computing, implementation of the teachings recited herein are not limited to a cloud computing environment. Rather, illustrative embodiments are capable of being implemented in conjunction with any other type of computing environment now known or later developed. Cloud computing is a model of service delivery for enabling convenient, on-demand network access to a shared pool of configurable computing resources, such as, for example, networks, network bandwidth, servers, processing, memory, storage, applications, virtual machines, and services, which can be rapidly provisioned and released with minimal management effort or interaction with a provider of the service. This cloud model may include at least five characteristics, at least three service models, and at least four deployment models.

The characteristics may include, for example, on-demand self-service, broad network access, resource pooling, rapid elasticity, and measured service. On-demand self-service allows a cloud consumer to unilaterally provision computing capabilities, such as server time and network storage, as needed automatically without requiring human interaction with the service's provider. Broad network access provides for capabilities that are available over a network and accessed through standard mechanisms that promote use by heterogeneous thin or thick client platforms, such as, for example, mobile phones, laptops, and personal digital assistants. Resource pooling allows the provider's computing resources to be pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction, such as, for example, country, state, or data center. Rapid elasticity provides for capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. Measured service allows cloud systems to automatically control and optimize resource use by leveraging a metering capability at some level of abstraction appropriate to the type of service, such as, for example, storage, processing, bandwidth, and active user accounts. Resource usage can be monitored, controlled, and reported providing transparency for both the provider and consumer of the utilized service.

Service models may include, for example, Software as a Service (SaaS), Platform as a Service (PaaS), and Infrastructure as a Service (IaaS). Software as a Service is the capability provided to the consumer to use the provider's applications running on a cloud infrastructure. The applications are accessible from various client devices through a thin client interface, such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service is the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service is the capability provided to the consumer to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components, such as, for example, host firewalls.

Deployment models may include, for example, a private cloud, community cloud, public cloud, and hybrid cloud. A private cloud is a cloud infrastructure operated solely for an organization. The private cloud may be managed by the organization or a third party and may exist on-premises or off-premises. A community cloud is a cloud infrastructure shared by several organizations and supports a specific community that has shared concerns, such as, for example, mission, security requirements, policy, and compliance considerations. The community cloud may be managed by the organizations or a third party and may exist on-premises or off-premises. A public cloud is a cloud infrastructure made available to the general public or a large industry group and is owned by an organization selling cloud services. A hybrid cloud is a cloud infrastructure composed of two or more clouds, such as, for example, private, community, and public clouds, which remain as unique entities, but are bound together by standardized or proprietary technology that enables data and application portability, such as, for example, cloud bursting for load-balancing between clouds.

A cloud computing environment is service oriented with a focus on statelessness, low coupling, modularity, and semantic interoperability. At the heart of cloud computing is an infrastructure comprising a network of interconnected nodes.

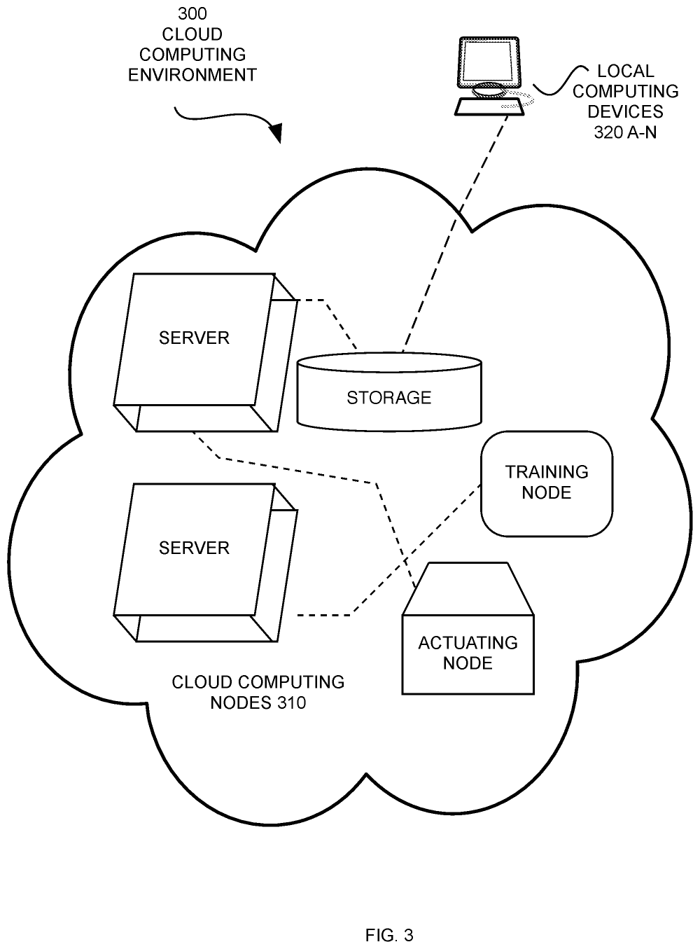

With reference now to FIG. 3, a diagram illustrating a cloud computing environment is depicted in which illustrative embodiments may be implemented. In this illustrative example, cloud computing environment 300 includes a set of one or more cloud computing nodes 310 with which local computing devices used by cloud consumers, such as, for example, local computing device 320 A-N may communicate. Cloud computing nodes 310 may be, for example, server 104, server 106, client 112, and client 114 in FIG. 1. A local computing device of local computing devices 320A-320N may be, for example, client 110 in FIG. 1. Local computing devices may be stationary such as sensors and may be mobile such as vehicles, hand-carried, and body-worn/implanted.

Cloud computing nodes 310 may communicate with one another and may be grouped physically or virtually into one or more networks, such as private, community, public, or hybrid clouds as described hereinabove, or a combination thereof. This allows cloud computing environment 300 to offer infrastructure, platforms, and/or software as services for which a cloud consumer does not need to maintain resources on a local computing device, such as local computing devices 320A-N. It is understood that the types of local computing devices 320A-N are intended to be illustrative only and that cloud computing nodes 310 and cloud computing environment 300 can communicate with any type of computerized device over any type of network and/or network addressable connection using a web browser or Internet Protocol, for example.

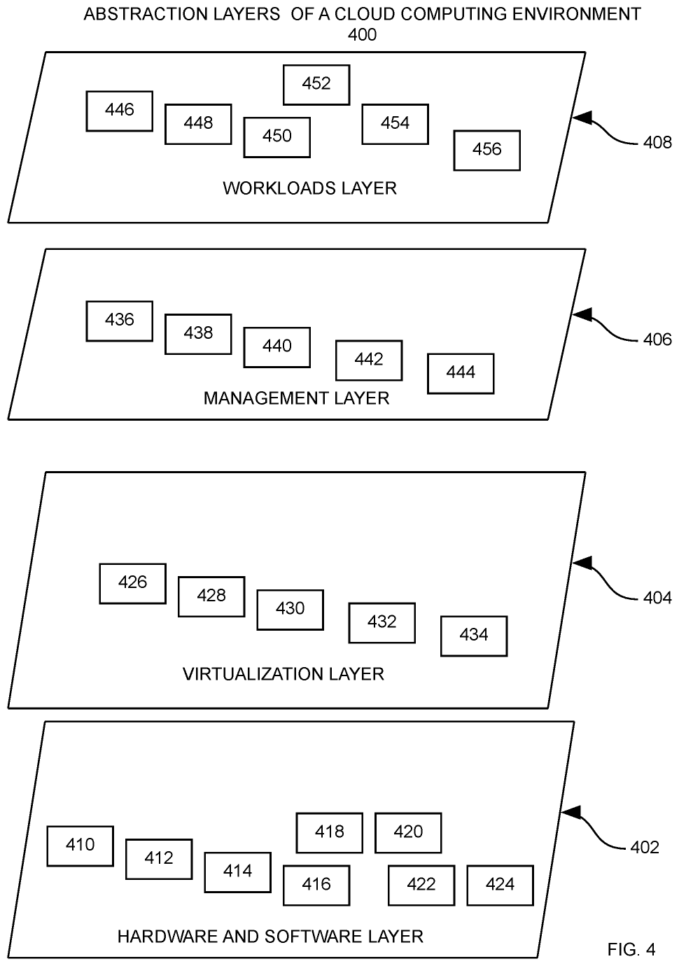

With reference now to FIG. 4, a diagram illustrating abstraction model layers is depicted in accordance with an illustrative embodiment. The set of functional abstraction layers shown in this illustrative example may be provided by a cloud computing environment, such as cloud computing environment 300 in FIG. 3. It should be understood in advance that the components, layers, and functions shown in FIG. 4 are intended to be illustrative only and embodiments of the invention are not limited thereto. As depicted, the following layers and corresponding functions are provided.

Abstraction layers of a cloud computing environment 400 include hardware and software layer 402, virtualization layer 404, management layer 406, and workloads layer 408. Hardware and software layer 402 includes the hardware and software components of the cloud computing environment. The hardware components may include, for example, mainframes 410, RISC (Reduced Instruction Set Computer) architecture-based servers 412, servers 414, blade servers 416, storage devices 418, and networks and networking components 420. In some illustrative embodiments, software components may include, for example, network application server software 422 and database software 424.

Virtualization layer 404 provides an abstraction layer from which the following examples of virtual entities may be provided: virtual servers 426; virtual storage 428; virtual networks 430, including virtual private networks; virtual applications and operating systems 432; and virtual clients 434.

In one example, management layer 406 may provide the functions described below. Resource provisioning 436 provides dynamic procurement of computing resources and other resources, which are utilized to perform tasks within the cloud computing environment. Metering and pricing 438 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 440 provides access to the cloud computing environment for consumers and system administrators. Service level management 442 provides cloud computing resource allocation and management such that required service levels are met. Service level agreement (SLA) planning and fulfillment 444 provides pre-arrangement for, and procurement of, cloud computing resources for which a future requirement is anticipated in accordance with an SLA.

Workloads layer 408 provides examples of functionality for which the cloud computing environment may be utilized. Example workloads and functions, which may be provided by workload layer 408, may include mapping and navigation 446, software development and lifecycle management 448, virtual classroom education delivery 450, data analytics processing 452, transaction processing 454, and security management 456.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to providing interactive content for display, the systems and methods described herein can include applied to other environments in which data included in a log database used and compared to data corresponding to previous requests for content and responsive to determining a change in the data, identifying one or more content elements to which to attribute the credit for the change. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A scene summary system comprising:
a plurality of Smartened Security Surveillance Edge devices; configured to determine and transmit Video Frame Foreground Content Event Metadata; to
a Cloud Analytics Processing Unit; whereby, prerecognition of events is captured by distinguishing a foreground content change from background content in each video frame and whereby communication performance is improved by only transmitting meta data on foreground content.

2. The system of claim 1 further comprising:
an Object Signature Vectors store; and
a Regional Probability of Interest store, both communicatively coupled to the Cloud Analytics Processing Unit, whereby object recognition indicia are stored and the most and least likely positions of objects in the video frames are stored when determined by the Cloud Analytics Processing Unit based on bounding box coordinates and foreground content event meta data.

3. The system of claim 2 further comprising:
an Edge Device Directed Topology store; and
an Abnormal Events Rules store, both communicative coupled to the Cloud Analytics Processing Unit, whereby each edge device is connected to its adjacent edge devices by directional indicia for an object normally arriving and by directional indicia for an object normally departing; and whereby said Abnormal Events Rules include trigger conditions which when true, cause action requests to be recorded and transmitted through the communication channels.

4. The system of claim 3 further comprising:
a plurality of self-actualized security surveillance edge devices (S-AED) communicatively coupled to the Abnormal Events Rules store and to each other S-AED; and further coupled to at least one
Physical Access Actuator and at least one Physical Access Alarm; whereby, upon determining a trigger condition as an Abnormal Event is TRUE, a first S-AED transmits an action request to at least one of a second S-AED, a physical access actuator, and a physical access alarm.

5. A security surveillance system comprising:
a plurality of content triggered mesh network of surveillance sensors, said sensors comprising video cameras which transmit metadata concerning foreground objects within a region of interest; coupled to
a machine learning variance analysis server, said server comprising means for determination of a normal range of content from historical aggregation of meta data and means for training said sensor on a region of interest; coupled to
a security event determination rule filter device, said filter triggering on intrusion of an object type into an incompatible region of interest; coupled to
a physical access control facilitation actuator, said actuator enabling portal operation between a first responder and location of incident or object interception.

6. The system of claim 5 wherein content-triggered mesh network of surveillance sensor further comprises at least one of:
an optical sensor;
a chemical sensor;
a vibration sensor;
a combustion sensor;
an audio sensor;
an acceleration sensor;
an infrared sensor;
a temperature sensor;
a three dimensional image sensor;
an electro-magnetic sensor;
a microphone and speaker;
a pressure sensor; and
a radar transceiver.

7. The system of claim 5 wherein machine learning variance analysis server further comprises at least one of:
means for training a sensor on regions of interest;
means for training a sensor to distinguish between objects in foreground and objects in background;
means for aggregating metadata by location, by hour of day, by day of week, by calendar;
means for learning a normal range of metadata by location, by hour of day, by day of week, by calendar;
means for determining adjacency of cameras capturing the same objects within a period of time;
means for determining a range of metadata for rate of change and direction of travel across a plurality of physically adjacent cameras;
means for determining linger times, waiting time, length of queues; and
means for training sensors on upload criteria based on content and change of content.

8. The system of claim 5 wherein a security event determination rule filter further comprises:
a circuit which triggers on a current metadata which is outside a machine learned range of normal historical value by a standard deviation;
a circuit which triggers when an object exiting a region of interest is unequal to the object entering said region of interest;
a circuit which triggers when occupants exit a vehicle stopped in a region of interest;
a circuit which triggers when a package is discarded in a region of interest;
a circuit which triggers when a type of object intrudes on a region of interest which is inappropriate for the type of object; and
a circuit which triggers on an amplitude of metadata which exceeds a threshold.

9. The system of claim 5 wherein a physical access control facilitation actuator further comprises at least one of:
a mobile security sensor elevator;
an airborne security sensor launcher;
a portal actuator;
a barrier actuator;
a display of a map guiding a first responder to most direct and quickest arrival to an incident or intercept location;
a display of a map and location of a security event;
a display of a map and video stream of most likely paths available to an object subsequent to a security event;
a display of a map and video streams of path taken by an object preceding a security event; and,
alarm, announcements, illumination, or environmental adjustments.
